(19) United States
(12) Patent Application Publication
(10) Pub. No.: US 2018/0165290 A1
(43) Pub. Date: Jun. 14, 2018

(54) MEDIA FILE BROWSING METHOD AND INFORMATION PROCESSING DEVICE

(71) Applicant: Lenovo (Beijing) Co., Ltd., Beijing (CN)

(72) Inventors: Xiaomei LI, Beijing (CN); Yaqiang WU, Beijing (CN); Zhepeng WANG, Beijing (CN)

(21) Appl. No.: 15/837,753

(22) Filed: Dec. 11, 2017

(30) Foreign Application Priority Data
Dec. 9, 2016 (CN) 201611131412.4

(51) Int. Cl. G06F 17/30; G06F 3/0481

(52) U.S. Cl. CPC G06F 17/30058; G06F 3/0488; G06F 3/04817; G06F 17/30126

(57) ABSTRACT

A media file browsing method and an information processing device are provided. The method comprises: organizing a media file set that includes a plurality of media files into one or more groups of media files, each group comprising one or more media files having a common characteristic; displaying a display image that corresponds to the or each group of media files via a display screen; and responsive to receiving an input command directed towards the display image, displaying the one or more media files from the group of media files that corresponds to the display image.

### CROSS-REFERENCES TO RELATED APPLICATIONS

This application claims priority of Chinese Patent Application No. 201611131412.4, filed on Dec. 9, 2016, the entire contents of which are hereby incorporated by reference.

### FIELD OF THE INVENTION

The present disclosure generally relates to the technical field of information processing and, more particularly, relates to a media file browsing method and an information processing device.

### BACKGROUND

Currently, when a user uses an information processing device such as a cellphone to take a photo or shoot a video file, various photos or video files may often be obtained on a same scenery. To save such files, the information processing device needs to allocate a large amount of memory resources and, in such allocated memory resources, a large amount of photos or videos with high similarity may be stored. Accordingly, when the user browses media files using the information processing device, because similar media files shot at the same time may be displayed on the display screen simultaneously, similar media files may occupy the entire display screen. Thus, other dissimilar files photos may not be displayed timely, which can eventually result in a poor experience for the user browsing the media files and also cause inconvenience to the browsing operation.

### BRIEF SUMMARY OF THE DISCLOSURE

One aspect of the present disclosure provides a media file browsing method. The method comprises: organizing a media file set that includes a plurality of media files into one or more groups of media files, each group comprising one or more media files having a common characteristic; displaying a display image that corresponds to the or each group of media files via a display screen; and responsive to receiving an input command directed towards the display image, displaying the one or more media files from the group of media files that corresponds to the display image.

Another aspect of the present disclosure provides an information processing device. The device comprises a processor and a display nit. The processor is configured to organize a media file set that includes a plurality of media files into one or more groups of media files, each group comprising one or more media files having a common characteristic; display a display image that corresponds to the or each group of media files via the display unit; and display the one or more media files from the group of media files corresponding to the display image, in response to receive an input command directed towards the display image via the input device.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in disclosed embodiments of the present invention, drawings necessary for the description of the disclosed embodiments are briefly introduced hereinafter. Obviously, the drawings described below are only some embodiments of the present invention, and it is possible for those ordinarily skilled in the art to derive other drawings from these drawings without creative effort.

FIG. 1 illustrates a flow chart of a multimedia file browsing method according to embodiments of the present disclosure;

FIG. 2A illustrates a flow chart of another multimedia file browsing method according to embodiments of the present disclosure;

FIG. 2B illustrates a schematic view of a display screen displaying thumbnail images of display images according to embodiments of the present disclosure;

FIG. 3 illustrates a flow chart of another multimedia file browsing method according to embodiments of the present disclosure;

FIG. 4 illustrates a flow chart of another multimedia file browsing method according to embodiments of the present disclosure;

FIG. 5A illustrates a flow chart of another multimedia file browsing method according to embodiments of the present disclosure;

FIG. 5B illustrates an action input image for an opened media file according to embodiments of the present disclosure; and

FIG. 6 illustrates a block diagram of an information processing device according to embodiments of the present disclosure.

### DETAILED DESCRIPTION

Hereinafter, technical solutions in embodiments of the present disclosure will be described clearly and fully with reference to the accompanying drawings. Exemplary embodiments of the present disclosure and the various features and advantageous details thereof are explained more fully with reference to the non-limiting exemplary embodiments that are illustrated in the accompanying drawings and detailed in the following descriptions. It should be noted that, features illustrated in the accompanying drawings are not necessarily drawn to scale. Well-known components are omitted in the present disclosure. The examples used herein are intended merely to facilitate an understanding of ways in which the embodiments herein can be practiced and to further enable those skilled in the relevant art to further implement the disclosed embodiments. Thus, the examples shall not be construed as limiting the scope of the disclosed embodiments herein.

Unless otherwise explained, all technical and scientific terms used herein have the same meaning as commonly understood by one of ordinary skill in the art to which the present disclosure belongs. The terms “First”, “second”, etc., used in the present disclosure do not denote any order, quantity or importance, but rather are used to distinguish between different objects or units, etc. Further, in each embodiment of the present disclosure, the same or similar reference numerals represent the same or similar components.

Hereinafter, with reference to the accompanying drawings, specific implementation methods of the media file browsing method and the information processing device provided by embodiments of the present disclosure are illustrated in detail.

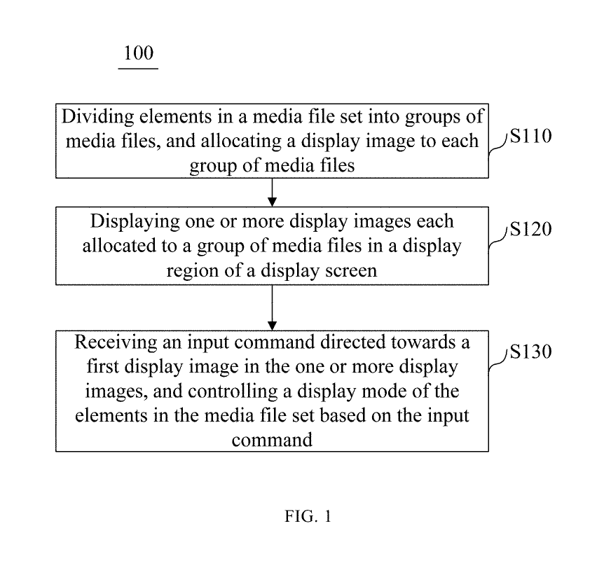

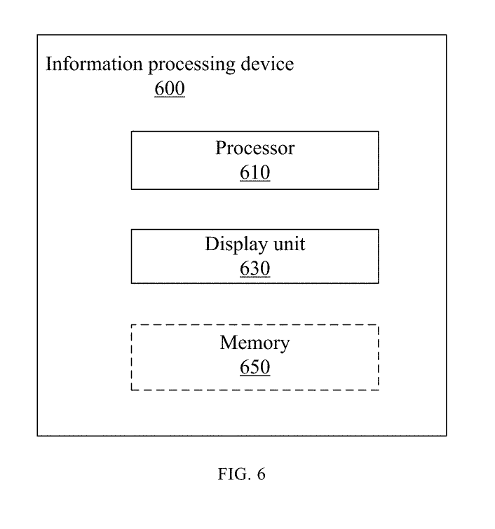

FIG. 1 illustrates a flow chart of a media file browsing method 100 according to embodiments of the present disclosure. The media file browsing method 100 may be applied to an information processing device (as shown in FIG. 6). Referring to FIG. 1, the media file browsing method 100 may include the following steps (Step S110˜Step S130).

In Step S110, a media file set that includes a plurality of elements are organized or divided into one or more groups of media files. An element in the media file set may be a media file, such as a picture or a video, etc., or a file in other formats. Optionally, all elements in the media file set are media files. It should be noted that at least one group of media files may comprise a single element or media file.

A display image is allocated to each group of media files, and the display image of a group of media files may be related to content of a media file included in the group of media files. Further, the media file set may be organized based on a common characteristic. That is, each group comprising one or more media files may have a common characteristic. Optionally, the media file set may be organized based on two or more common characteristics.

In Step S120, one or more display images corresponding to one group or a plurality of groups of media files are displayed via a display region. That is, one or more display images each allocated to a group of media files is displayed within a display region of a display screen.

In Step S130, when an input command of a first display image from the one or the plurality of display images is received, a display mode of the elements in the media file set is controlled based on the input command.

In some embodiments, in Step S110, the elements (e.g., media files or multimedia files) in the media file set may be organized into groups of media files based on a first common characteristic or a second common characteristic. The first common characteristic may be related to the content of the media files. The second common characteristic may be related to media file generation time, where the media file generation time refers to the time a media file is generated. Accordingly, the media files divided into a same group in the plurality of groups may have certain similarity.

For example, when dividing the elements in the media file set into groups of media files (i.e., grouping or organizing the elements in the media file set) based on the content of the media files (i.e., the elements), media files that are highly similar to each other may be categorized into one group based on the content similarity. Or, based on whether the same content (e.g. the same type of flower, the same type of animal, etc.) is included, media files including the same content may be categorized into one group.

Optionally, grouping may be performed based on person(s) in the content of the media file. That is, the elements (i.e., media files) in the media file set may be divided into different groups based on the person(s) in the content of each element. For example, media files showing families being together may be treated as a first group of media files, and media files showing colleagues gathering together may be treated as a second group of media files.

Further, optionally, grouping may be performed based on the generation time of the media file (i.e., media file generation time). For example, when grouping is performed based on time, files obtained within a certain period of time may be categorized into the same group. In one embodiment, a plurality of images obtained within the same second may be categorized into one group of media files. In another embodiment, a plurality of images obtained within a specific year may be categorized into one group of media files. In other embodiments, a plurality of images that are took within a specific month may be categorized into one group of media files, etc.

Further, optionally, the media files may be organized or divided into groups based on two different common characteristics of the media files, and the two common characteristics may be, for example, the content and the time of the media files, respectively. For example, media files showing families being together in each month may be organized into one group, and media files showing colleagues being together in each month may be organized into another group. Under such situation, the families and the colleagues are the content of the media files (i.e., person) for dividing media files into different groups. However, the present disclosure is not limited thereto, and the specific common content used for grouping may be other content reflected by the media files than person(s). For example, when grouping is performed based on the content of the multimedia file, multimedia files including only sceneries may be used as a first group of multimedia files, and multimedia files including at least one human character (i.e., a person) may be used as a second group of multimedia files.

In some embodiments, the media file may at least include a photo or a video file, etc. In some embodiments, a process of allocating a display image to each group of media files (Step S110) may include: using one media file in each group of media files as a display image, or allocating a new media file for each group of media files that is different from any media file in such group of media files as the display image.

Optionally, the display image in Step S110 being related to the content of a media file in the group of media files to which the display image is allocated may refer to the display image being a specific media file or being a part of a specific media file. For example, a media file may be selected from each group of media files as the display image. That is, when the media files are photos, the display image may be any photo from the group of photos, and when the media files are video files, the display image may be an image corresponding to a certain frame of image in the video file.

In some embodiments, each group of media files obtained after the organization/dividing process in Step S110 may be saved in one folder. The display image may be used as a display icon of the folder.

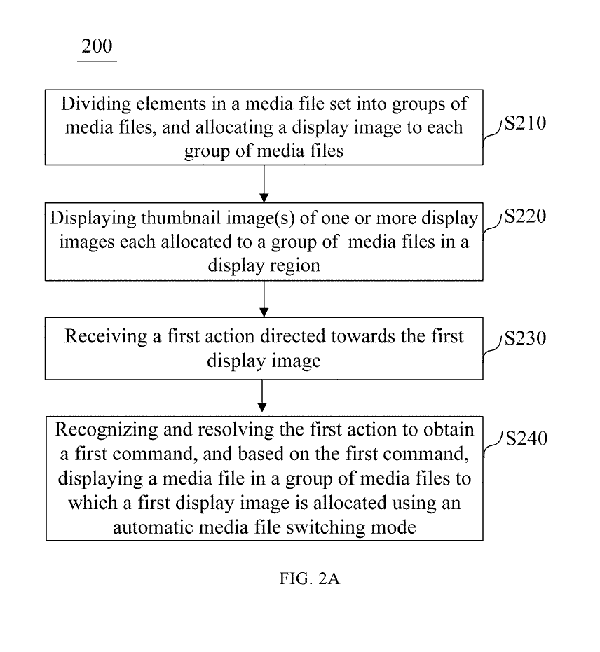

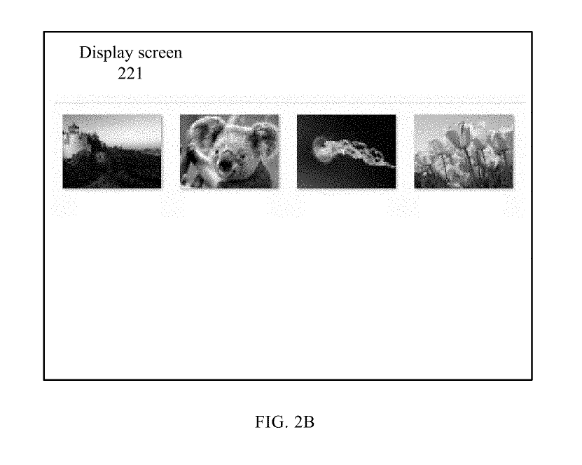

FIG. 2B illustrates a schematic view of a display screen displaying thumbnail images of display images according to embodiments of the present disclosure. More specifically, FIG. 2B illustrates thumbnail images of four display images displayed in a display screen 221. As shown in FIG. 2B, in some embodiments, Step S120 may include further displaying thumbnail image(s) of one or more display images each allocated to a group of media files displayed in the display region.

For example, in Step S120, a certain content is displayed in an image browsing interface. More specifically, the image browsing interface may be accessed by opening a photo album application or a file manager or other applications that need to view an image. Optionally, in Step S120, a certain content may be displayed in a video browsing interface. More specifically, the video browsing interface may be accessed by opening a video application, or by opening the file manager or other applications that need to view the video.

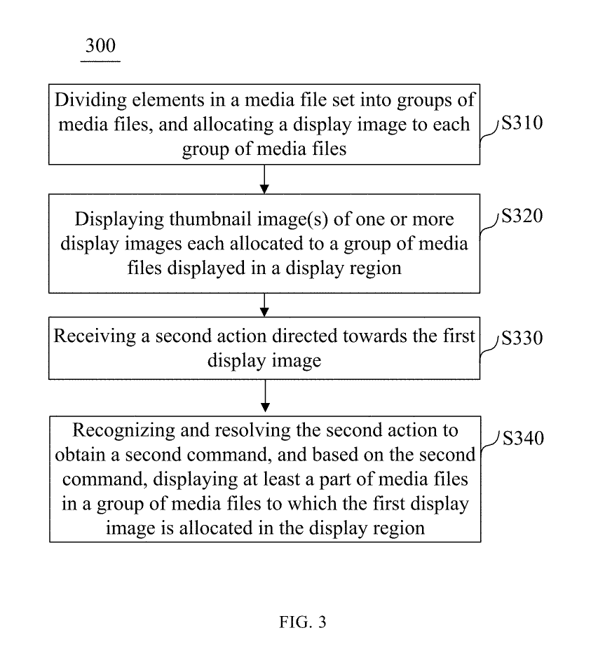

For example, when in Step S120, thumbnail image(s) of one or more display images are displayed, in Step S130, based on a related command directed towards the first display image that is inputted by the user, the display mode of the media files (i.e., elements in the media file set) may be controlled. More specifically, related examples provided by FIG. 2A and FIG. 3 may be referred to for illustrative purposes.

In some other embodiments, Step S120 may further include opening a first media file corresponding to the first display image, and displaying the first media file in the display region, where the first display image corresponds to the first group of media files. The first display image corresponding to the first group of media files specifically refers to a display image allocated to the first group of media files.

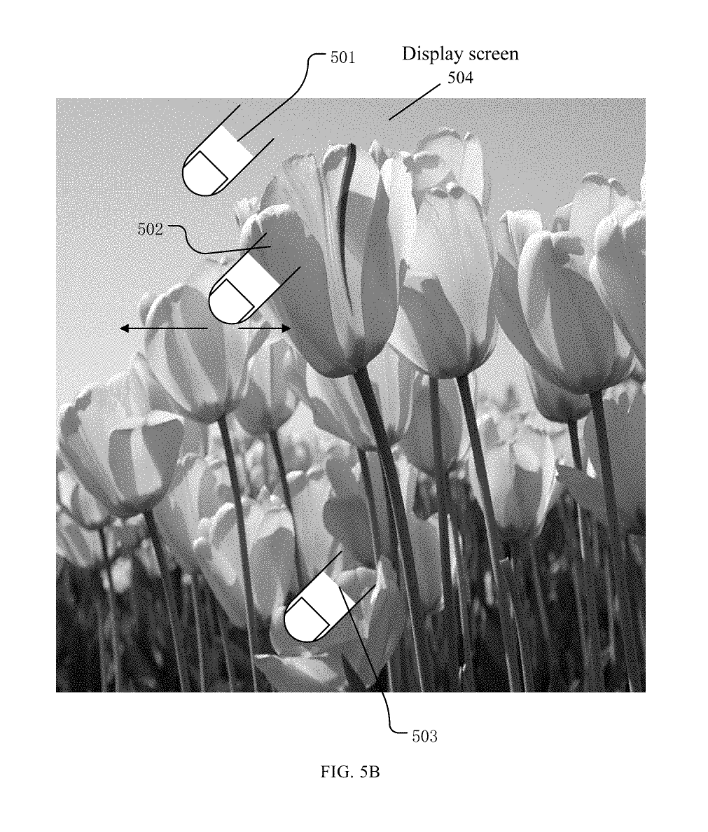

For example, when the first media file is displayed in Step 120, Step S130 may include: receiving a third action directed towards the first media file; recognizing an input command corresponding to the third action based on a parameter related to the third action; and performing switching on a display content in the display region based on the recognized input command (a specific related example is provided hereinafter with reference to FIG. 5).

In some embodiments, the first display image in Step S130 is a certain display image or a media file that has received a user input action. In some embodiments, in Step S130, controlling the display mode of the elements in the media file set based on the input command may at least include: controlling the display mode of the media files in a group corresponding to the first display image and controlling the display mode of the media files in other groups that are different from the group corresponding to the first display image.

For example, examples of controlling the display mode of the media files in the group corresponding to the first display image may be found in Embodiment 1 and Embodiment 2. Examples of controlling the display mode of the media files in other groups that are different from the group corresponding to the first display image may be found in partial solutions in subsequent Embodiment 4.

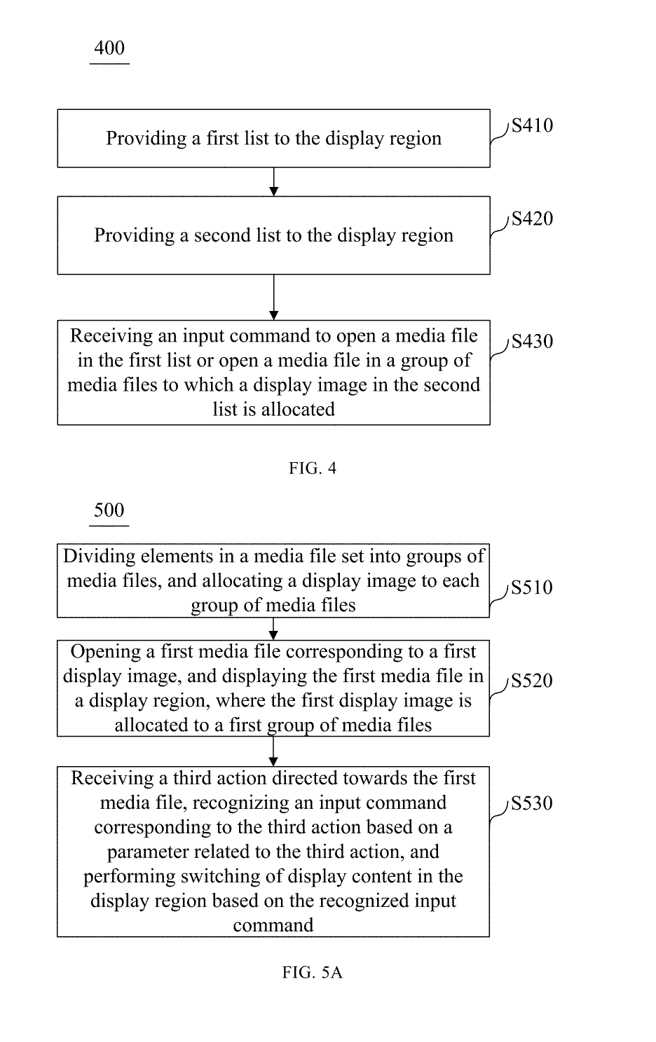

Hereinafter, the aforementioned media file browsing method 100 is illustrated in detail with reference to Embodiment 1, Embodiment 2, and Embodiment 3 provided by FIG. 2A˜FIG. 4.

### Embodiment 1

FIG. 2A illustrates a flow chart of a multimedia file browsing method according to embodiments of the present disclosure. As shown in FIG. 2A, the multimedia file browsing method may include Step S210, where elements in a media file set are organized or divided into groups of media files, and a display image is allocated to each group of media files obtained after the elements in the media file set are divided. The multimedia file browsing method may further include Step S220, where thumbnail image(s) of one or more display images corresponding to one group or a plurality of groups of media files is displayed in a display region. Further, the multimedia file browsing method may further include Step S230 and Step S240, and detailed descriptions of Step S230 and Step S240 will be provided hereinafter.

Step S210 and Step S220 provided in FIG. 2A may correspond to Step S110 and Step S120 displayed in FIG. 1, respectively, and thus detailed descriptions of Step S210 and Step S220 are not repeated herein. The difference between FIG. 2A and FIG. 1 lies in that, Embodiment 1 in FIG. 2A provides a specific implementation process of Step S130 illustrated in FIG. 1.

That is, Step S130 illustrated in FIG. 1 may specifically include Step S230 and Step S240 illustrated in FIG. 2A. More specifically, in Step S230, a first action directed towards the first display image is received. Further, in Step S240, a first command is obtained by recognizing and resolving the first action, and based on the first command, the media file(s) in a group of media files corresponding to the first display image is displayed using an automatic media file switching mode (hereinafter referred to as ‘automatic switching mode’).

For example, the first action may refer to an action of pressing the first display image with a duration longer than a first threshold. Optionally, the first action may be double-clicking on the first display image. The first action may also refer to an action that can be recognized by a processor, such as clicking on the first display image, etc.

In some embodiments, in Step S240, displaying the media file(s) using an automatic media file switching mode may specifically refer to opening one by one and displaying each media file included in a certain group of media files at a certain time interval. Further, in Step S240, full-screen or partial screen may be used to display the media file(s) in the automatic media file switching mode.

Referring to FIG. 2B, a display image corresponding to tulips (i.e., the fourth display image in FIG. 2B) may be used as an example for illustrative purposes. More specifically, when the display screen 221 displays thumbnail images of four display images corresponding to four groups of media files on the display screen 221 (corresponding to Step S220), a pressing action inputted by the user on the display image (i.e., the first display image) corresponding to the tulips may be received. For example, the pressing action may be an action of clicking and holding using a mouse, or an action of pressing on a touch screen. Such pressing action may be assumed to correspond to a first command, and receiving the pressing action inputted by the user on the display image corresponding to the tulips may thus correspond to Step S230.

Further, the pressing action is resolved to obtain the first command, and each media file in the group of media files corresponding to the display image of the tulips is opened one by one on the entire display screen 221 based on the first command. That is, the media files opened each time may entirely cover the display region of the display screen 221. The display screen 221 may no longer be able to display the thumbnail images of the four display images (corresponding to Step S240).

Optionally, each media file in the group corresponding to the display image of tulips may be opened one by one in a partial display region of the display screen 221 based on the first command. The display screen 221 may still simultaneously display thumbnail images of four display images. For example, the lower region of FIG. 2B may be used to open each media file in the group of media files to which the display image of tulip is allocated one by one, while the upper region of the display screen 22 still displays the four display images).

### Embodiment 2

FIG. 3 illustrates a flow chart of another multimedia file browsing method according to embodiments of the present disclosure. As shown in FIG. 3, the multimedia file browsing method may include Step S310, where elements in a media file set are divided into groups of media files, and a display image is allocated to each group of media files obtained after the elements in the media file set are divided. The multimedia file browsing method may further include Step S320, where thumbnail image(s) of one or more display images corresponding to one group of media files or a plurality of groups of media files is displayed in a display region.

Step S310 and Step S320 may correspond to Step S110 and Step S120 illustrated in FIG. 1, respectively, and are thus not repeated herein. Further, referring to FIG. 3, the multimedia file browsing method may further include Step S330 and Step S340. FIG. 3 more fully displays the specific implementation process of Step S130 in FIG. 1. That is, Step S130 illustrated in FIG. 1 specifically includes Step S330 and Step S340 shown in FIG. 3.

More specifically, in Step S330, a second action directed towards the first display image is received. Further, in Step S340, the second action is recognized and resolved to obtain a second command, and at least partial media files in a group of media files corresponding to the first display image are displayed simultaneously in a thumbnail image displaying mode in the display region based on the second command.

For example, the second action may refer to an action of pressing the first display image with a duration longer than the first threshold. Optionally, the second action may be double-clicking on the first display image, or may be an action that can be recognized by the processor, such as clicking on the first display image, etc.

It should be understood that, when the user inputs an action directed towards the same first display image, the second action needs to be an action different from the first action. For example, the action with pressing time on the first display image exceeding a certain period of time may be used as the first action, and the action that clicks the first display image may be the second action.

For example, Step S340 may use the thumbnail image displaying mode to display the media file(s). When the number of media files in a certain group is sufficiently small or the display screen is sufficiently large, in Step S340, the thumbnail images of such group of multimedia files may be displayed all at once. However, if the number of media files included in a certain group of media files is very large, in Step S340, thumbnail images of a part of the multimedia files may be displayed at the same time, and the thumbnail images of the rest part of the multimedia files that belong to the same group may be displayed after switching.

Referring to FIG. 2B, the display image corresponding to the tulips is still used as an example for illustrative purposes herein. When the display screen 221 displays the thumbnail images of four display images corresponding to four groups of media files (corresponding to Step S320), a clicking action on the display image (i.e., the first display image) corresponding to the tulips inputted by the user may be received. Such clicking action may be assumed to correspond to the second command, and receiving the clicking action inputted by the user on the display image corresponding to the tulips may thus correspond to Step S330.

Further, the clicking action is resolved to obtain a second command, and 221 based on the second command, a plurality of media files in a group of media files corresponding to the display image of the tulips are displayed in a thumbnail image displaying mode on the display screen. That is, the thumbnail images corresponding to the plurality of media files may entirely cover the display region of the display screen 221. The display screen 221 may no longer display the thumbnail images of the four display images (corresponding to Step S340).

Optionally, a plurality of media files in a group of media files corresponding to the display image of the tulips is displayed in the thumbnail image displaying mode in partial display region of the display screen 221 based on the second command. Under such situation, the display screen may simultaneously display thumbnail images of four display images. For example, the lower region of FIG. 2B may display the thumbnail images of a plurality of media files in the group corresponding to the display image of the tulips, and the upper region of the display screen 221 may still display the four display images.

More specifically, if the group that the display image of the tulips correspond to includes six photos of six different flowers, then, in Step S340, a part of the display region or the entire display region may be used to display the thumbnail images of the six photos corresponding to the six flowers.

Other than the aforementioned Embodiment 1 and Embodiment 2, the present disclosure further provides Embodiment 3.

### Embodiment 3

FIG. 4 illustrates a flow chart of another multimedia file browsing method according to embodiments of the present disclosure. Embodiment 3 of the present disclosure may be based on Embodiment 1 or Embodiment 2, and further, Embodiment 1 and Embodiment 2 that Embodiment 3 based on may need to use a part of display screen, instead of the whole display screen, to display the multimedia file.

More specifically, when the media files are displayed in an automatic switching mode based on Embodiment 1 or when a plurality of multimedia files are displayed simultaneously in a thumbnail image displaying mode based on Embodiment 2, the multimedia file browsing method 200 may further include the steps illustrated in FIG. 4.

Referring to FIG. 4, the multimedia file browsing method 400 may include Steps S410-S430. In Step S410, a first list is provided to the display region, where the first list relates to one or a plurality of media files that belong to a same group as the media file that is being displayed. In Step 420, a second list is provided to the display region, where the second list relates to one or a plurality of display images. Further, in Step S430, an input command may be received to open a media file in the first list or open a media file in a group corresponding to a display image in the second list.

For example, different regions of the display screen may be used to display the multimedia file and the first list or the second list, respectively. The upper region of the display screen may display the media files in an automatic switching mode illustrated in Embodiment 1, and the lower region of the display screen may simultaneously provide the first list or the second list. Or, the upper region of the display screen may use the automatic switching mode illustrated in Embodiment 2 to display the media files, and the lower region of the display screen may simultaneously provide the first list or the second list.

It should be understood that, a plurality of combinations may be included for a one-time display of different regions of the display screen. For example, combination 1 may be a combination of the upper portion ad the lower portion, and combination 2 may be a combination of left portion and right portion. Further, two portions in different combinations may be used to display the multimedia file and the list (including the first list and the second list), respectively.

Further, the display screen may be divided into three different display regions. For example, the first display region is configured to use the method in Embodiment 1 or Embodiment 2 to display the multimedia files, the second display region is configured to provide the first list to the user, and the third display region is configured to provide the second list to the user.

For example, the multimedia files listed in the first list and the multimedia file that is currently displayed may belong to a same group of media files. For example, when a certain multimedia file in the first group of media files is displayed using the automatic switching mode, the first list may be a list showing a plurality of rest media files included in the first group of multimedia files. Further, the second list may be a list of a plurality of display images. For example, when a certain multimedia file in the first group of multimedia files is being displayed using the automatic switching mode, the second list includes a display image of the second group of multimedia files, a display image of the third group of multimedia files, . . . , and a display image of an i^{th} group of multimedia files, where i represents the total number of groups obtained after dividing the multimedia file set into different groups.

When the user clicks a certain media file in the first list, the media file may be correspondingly opened and displayed, and when the user clicks a certain display image in the second list, each multimedia file in a group of multimedia files corresponding to the display image may be displayed. For example, the automatic switching mode or the thumbnail image displaying mode may be used to display each multimedia file in the group of multimedia files corresponding to the aforementioned display image displayed in the second list.

FIG. 5A illustrates a flow chart of another multimedia file browsing method according to embodiments of the present disclosure. Hereinafter, with reference to FIG. 5A and Embodiment 4, the aforementioned media file browsing method is illustrated in detail.

The media file browsing method 500 illustrated in FIG. 5 corresponds to the specific implementation process of each step included in the multimedia file browsing method 100 illustrated in FIG. 1. More specifically, Step S510 in FIG. 5 is the same as Step S110 illustrated in FIG. 1, Step S520 in FIG. 5 is a specific implementation method of Step S120 illustrated in FIG. 1, and Step S530 in FIG. 5 is a specific implementation of Step S130 illustrated in FIG. 1.

### Embodiment 4

Referring to FIG. 5A, the media file browsing method 500 may include Step S510, where elements in a media file set are divided into groups of media files, and a display image is allocated to each group of media files obtained after dividing the elements in the media file set. The method 500 may further include Step S520, where a first media file corresponding to a first display image is opened, and the first media file is displayed in a display region of a display screen, where the first display image is allocated to the first group of media files. Step S520 may correspond to a step in Step S120, where one or more display images corresponding to one group of media files or a plurality of groups of media files are displayed in the display region.

The method 500 may further include Step S530, where a third action directed towards the first media file is received, an input command corresponding to the third action is recognized based on a parameter related to the third action, and switching of the display content is performed in the display region based on the recognized input command. Step S530 may correspond to a step in Step S130, where an input command of the first display image is received, and based on the input command the display mode of the media files corresponding to the display image is controlled.

In some embodiments, in Step S520, the whole screen is used as the display region to display the first media file. For example, FIG. 5B illustrates an action input image for an opened media file according to embodiments of the present disclosure. As shown in FIG. 5B, the display screen 504 displays content of an opened tulip photo in a full-screen mode.

Optionally, the first media file and the display image may be the same multimedia file. Or, the first media file may be a media file different from the display image, and the first media file and the display image may both belong to the first group of media files. The first group of media files may be a group of media files among the plurality of groups of media files obtained after dividing the multimedia file set into different groups.

In some embodiments, in Step S530, a certain action inputted by a user directed towards the first media file is received. In some embodiments, if the parameter in Step S530 satisfies a first condition, a second media file is displayed using a switching mode, where the second media file and the first media file belong to elements in the first group of media files. If the parameter in Step S530 satisfies the second condition, a third media file is displayed using the switching mode, where the third media file is an element belonging to the second group of media files, and the third media file corresponds to the display image of the second group of media files.

More specifically, when the parameter related to the third action includes the occurrence region of the third action, the first condition refers to the third action being located in a first region of the display region, and the second condition refers to the third action being located in a second region of the display region. When the parameter related to the third action includes a movement direction of the third action, the first condition refers to the third action being a sliding movement that slides in a first direction, and the second condition refers to the third action being a sliding movement that slides in another direction different from the first direction (e.g., a second direction).

Step S530 may further include the following two specific implementation methods. For example, the first condition and the second condition may be related to different occurrence regions that the third action is located in the display screen, such as the action occurrence region of a finger 501 and a finger 503 as illustrated in FIG. 5B.

More specifically, when the parameter related to the third action includes the occurrence region of the third action, and the corresponding Step S530 specifically includes: when the third action is located in the first region of the first media file (e.g., the region where the finger 501 is located in FIG. 5B, which corresponds to the upper region of the media file), the action is recognized to be the first input command. The first input command is configured to instruct and display the present group of media files using the mode of automatic switching. When the third action is located in the second region of the first media file (e.g. the region where the finger 503 is located in FIG. 5B, corresponding to the lower region of the media file), the third action is recognized to be a second input command, where the second input command is configured to instruct and display other groups of media files.

For example, the first region and the second region may be the upper and lower portions of the display region corresponding to the first media file, respectively (FIG. 5B uses the finger 501 and the finger 503 to denote different regions, respectively). Or, the first region and the second region may be the left and right portions of the display region corresponding to the first media file, respectively (not illustrated in the figure).

Further, for example, the first condition and the second condition may be both related to the movement direction of the third action, and may be a movement direction of the finger 502 illustrated in FIG. 5B. More specifically, the parameter related to the third action may include the movement direction of the third action. The corresponding Step S530 may thus specifically include: when the third action is a sliding action that slides in the first direction (e.g., indicated by an arrow pointing to the left using the finger 502 in FIG. 5B), the action is recognized to be the first input command. The first input command is configured to instruct and display the present group of media files by automatic switching.

Further, when the third action is a sliding action that slides in another direction different from the first direction (e.g., denoted by an arrow pointing to the right using the finger 502 in FIG. 5B), the third action is recognized as the second input command, where the second input command is configured to instruct and display other groups of media files. For example, the first direction and the second direction may be directions to the left or to the right, respectively (FIG. 5B uses the finger 502 to illustrate two sliding directions), or may be directions upwards or downwards, respectively (not illustrated in the figure).

It should be understood that, different labels of the fingers illustrated in FIG. 5B may not necessarily represent different fingers, which are used only for the ease of description. Further, different regions illustrated in FIG. 5B and different movement directions are for explaining the technical solutions of the present disclosure but not constituting limitations on the scope of the disclosed technical solutions.

In some embodiments, the number of different regions may be set to be greater than 2, and the total number of specifically configured regions may be adjusted to be consistent with the number of different to-be-set commands. For example, for five types of input commands, five different action input regions may be configured, respectively. Further, related commands may be resolved by detecting different regions. It should be understood that, the number of the movement directions may also be configured to be greater than two.

Hereinafter, an information processing device 600 provided by embodiments of the present disclosure is illustrated with reference to FIG. 6. FIG. 6 illustrates a block diagram of an information processing device according to embodiments of the present disclosure. As shown in FIG. 6, the information processing device 600 may include a processor 610, a display unit 630, and a memory 650. Optionally, the information processing device 600 may further include an input device. The input device may be a mouse, a keyboard, or any other device to receive an input command.

More specifically, the processor 610 may be configured to divide or organize elements in a media file set into groups of media files and allocate a display image to each group of medial files obtained after dividing the elements in the media file set. The display image is related to content of a media file in the group of media file to which the display image is allocated. The processor 610 is further configured to receive an input command of the first display image from the one or the plurality of display images, and control the display mode of elements in the media file set based on the input command.

Further, one element in the media file set may be a media file. The processor for dividing the elements in the media file set into groups is specifically configured to divide the elements in the media file set into groups based on at least one characteristic of each media file included in the media file set.

In some embodiments, the at least one characteristic that the processor 610 is based on includes: the first characteristic related to the media file content or the second characteristic related to the generation time of the media file.

Further, the display unit 620 may be configured to display one or more display mages corresponding to one or more media files in a display region of a display screen. In some embodiments, the display unit 630 is configured to display the thumbnail image(s) of one or more display images corresponding to one or more media files displayed in the display region.

In some embodiments, the processor 610 is further configured to receive the first action directed towards a certain display image. That is, a first action is inputted to the first display image. Further, the processor 610 is configured to recognize and resolve the first action to obtain a first command, and based on the first command, the processor 610 displays the media files in a group of media files corresponding to the first display image using an automatic media file switching mode. For example, the first action may be an action of pressing the first display image with a duration longer than the first threshold, or action of double clicking on the first display image. Optionally, the first action may also be an action recognizable by the processor, such as clicking on the first display image, etc.

In some embodiments, the processor 610 is further configured to receive a second action directed towards a certain display image. That is, the second action is inputted to the first display image. The processor is further configured to recognize and resolve the second action to obtain a second command, and based on the second command, display at least a part of the media files in a group of media files corresponding to the first display image in the display region using a thumbnail image displaying mode. For example, the second action may be an action of pressing the first display image with a duration longer than the first threshold, or may be an action of double clicking on the first display image. Further, the second action may be an action recognizable by the processor, such as clicking on the first display image.

However, it should be understood that, for the same first display image input command, the first action and the second action may be different types of actions. For example, when the first action is an action of pressing on the first display image with a duration exceeding the first threshold, the corresponding second action may be clicking on the first display image.

In some embodiments, the processor 610 is further configured to provide a first list to the display region, where the first list is a list of a plurality of media files that belong to a same group as the media file currently being displayed. Or, the processor 610 is configured to provide a second list to the display region, where the second list is a list of a plurality of display images. Further, the processor 610 may be configured to receive an input command to open a media file in the first list or open a media file in a group of media files to which a display image in the second list is allocated.

In some embodiments, the processor 610 may be configured to only provide the first list or only provide the second list, and receive the input command directed towards the first list or the second list. In some other embodiments, the processor 610 may be configured to simultaneously provide the first list and the second list, and receive the input command towards the first list and the second list.

For example, different regions of the display screen may be used to display the multimedia files and the first list or the second list, respectively. For example, the upper region of the display screen may display the media files in an automatic switching mode illustrated in Embodiment 1, and the lower region of the display screen may simultaneously provide the first list or the second list. Or, the upper region of the display screen may use the automatic switching mode illustrated in Embodiment 2 to display the media files, and the lower region of the display screen may simultaneously provide the first list or the second list.

It should be understood that, a plurality of combination methods may exist for a one-time display of different regions of the display screen. For example, combination 1 may be a combination of the upper portion and the lower portion, and combination 2 may be a combination of the left portion ad the right portion. Further, and two portions in different combinations may be used to display the multimedia file and the list (including the first list or the second list), respectively.

Further, the display screen may be divided into three different display regions, where the first display region is configured to use Embodiment 1 or Embodiment 2 to display the multimedia file, the second display region is configured to provide the first list to the user, and the third display region is configured to provide the second list to the user.

For example, the multimedia files listed in the first list and the multimedia file(s) being displayed may belong to the same group of multimedia files. For example, when a certain multimedia file in the first group of multimedia files is displayed using the mode of automatic switching, the first list is a list of a plurality of rest media files included in the first group of multimedia files. The second list may be a list of a plurality of display images. For example, when a certain multimedia file in the first group of multimedia file is displayed using the automatic switching mode, the second list may include the display image of the second group of multimedia files, the display image of the third group of multimedia files, . . . , the display image of an i^{th} group of multimedia files, where i represents the total number of groups after the multimedia file set are divided into groups.

When a user clicks a certain media file in the first list, the media file may be correspondingly opened and displayed, and when a user clicks a certain display image in the second list, each multimedia file in the group corresponding to the display image may be displayed. For example, the automatic switching mode or the thumbnail image displaying mode may be used to display each multimedia file in the group of media files to which a certain display image displayed in the second list is allocated.

In some embodiments, the display unit 630 is further configured to open the first media file corresponding to the first display image, and display the first media file in the display region, where the first display image corresponds to the first group of media files. The processor 610 is further configured to receive the third action directed towards the first media file, recognize the input command corresponding to the third action based on a parameter related to the third action, and performing switching of the display content in the display region based on the recognized input command.

Further, when the parameter related to the third action satisfies a first condition, a second media file is displayed using a switching mode, where the second media file is an element in the first group of media files. If the parameter related to the third action satisfies a second condition, a third media file is displayed using the switching mode, where the third media file is an element in the second group of media files, and the third media file corresponds to the display image of the second group of media files.

More specifically, when the parameter related to the third action includes the occurrence region of the third action, the first condition is about the third action being located in a first region of the display region, and the second condition is about the third action being located in a second region of the display region. When the parameter related to the third action include a movement direction of the third action, the first condition is about the third action being a sliding movement that slides in a first direction, and the second condition is about the third action being a sliding movement that slides in a second direction. The second direction is a direction different from the first direction.

For example, the display unit 630 may use the whole screen as the display region to display the first media file. The first media file and the display image may be the same multimedia file. Or, the first media file may be a media file different from the display image, and the first media file and the display image both belong to the first group of media files. The first group of media files herein may be a group of media files among the plurality of groups of media files.

For example, the processor 610 may be configured to receive a certain action inputted by the user directed towards the first media file.

For example, the first condition and the second condition may be related to the different generation regions that the third action is located in in the display screen. More specifically, the parameter related to the third action may include the occurrence region of the third action, and the corresponding processor 610 may be configured to, when the third action is located in a first region of the first media file, recognize the action as the first input command. The first input command is configured to instruct and display the present group of media files by automatic switching.

Further, when the third action is located in a second region of the first media file, the processor 610 may be configured to recognize the third action as the second input command, where the second input command is configured to instruct and display other groups of media files. Further, for example, the first region and the second region may be the upper portion and the lower portion of the display region corresponding to the first media file, respectively. Or, the first region and the second region may be the left portion and the right portion of the display region corresponding to the first media file, respectively.

Further, for example, the first condition and the second condition may be both related to the movement direction of the third action. More specifically, the parameter related to the third action may include the movement direction of the third action. Correspondingly, the processor 610 may be further configured to, when the third action is a sliding action that slides in the first direction, recognize the action as the first input command, where the first input command is configured to instruct and display the present group of the media files by automatic switching.

Further, when the third action is a sliding action that slides in another direction different from the first direction (i.e., the second direction), the processor 610 may be configured to recognize the third action as the second input command, where the second input command is configured to instruct and display other groups of media files. For example, the first direction and the second direction may be directions respectively pointing to the left or to the right, or may be directions pointing upwards or downwards, respectively.

In some embodiments, the aforementioned processor 610 may process a data signal, and may include various kinds of computational structures, such as a complex instruction set computer (CISC) structure, a reduced instruction set computer (RISC) structure, or a structure that implements a plurality of instruction set combinations. In some embodiments, the processor 610 may be a micro-processor. More specifically, the disclosed processor 610 may also be configured to execute instruction codes related to the media file browsing method.

In some embodiments, the aforementioned display unit 630 may be a display, and the display may be configured to display a multimedia file. For example, the display may be an LCD display, an LED display, or other displays. The display may include a display screen having a touch function or a touch-control function. The touch display or the touch-control display may sense the related action inputted by the user, transmit the acquired related action to the processor 610 for recognition, and eventually control the method that the display displays the media file based on the recognized result.

Further, in some embodiments, the information processing device 600 may further includes a memory 650. The memory 650 may save the instruction and/or data executed by the processor 610, or may store the code/instruction configured to implement the multimedia browsing method. Such instructions and/or data may include codes, and may be configured to implement some functions or all functions of one or more modules described in embodiments of the present disclosure.

For example, the storage 650 may include dynamic random-access memory (DRAM), static random access memory (SRAM), flash memory, optical memory, or other memories known to those skilled in the relevant art.

Those ordinarily skilled in the relevant art may realize that exemplary devices and algorithm steps described in the disclosed embodiments according to the present disclosure may be implemented by electronic hardware, software, or a combination of computer software and electronic hardware. Whether such functions are executed by method of hardware or software depend on the particular application and design constraints imposed on the technical solution. Those skilled in the art may implement described functionality in varying ways for each particular application, but such implementation shall not depart from the scope of the present disclosure.

Those skilled in the art to which the present disclosure pertains may clearly understand that, for purposes of convenience and briefness in description, for the specific working processes of the above-described devices and units, reference made be made to the corresponding processes in the aforementioned method embodiments, and repeated descriptions are not provided herein.

In various embodiments of the present disclosure, it should be understood that the disclosed device and method may be implemented by other manners. The device described above is merely for illustrative. For example, the units may be merely partitioned by logic function. In practice, other partition manners may also be possible. For example, various units or components may be combined or integrated into another system, or some features may be omitted or left unexecuted.

Units described as separated components may or may not be physically separated, and the components serving as display units may or may not be physical units. That is, the components may be located at one position or may be distributed over various network units. Optionally, some or all of the units may be selected to realize the purpose of solutions of embodiments herein according to practical needs.

When the described functions are implemented as software function units, and are sold or used as independent products, they may be stored in a computer accessible storage medium. Based on such understanding, the technical solutions of the present disclosure, or the portions contributing to the prior art may be embodied in the form of a software product. The computer software product may be stored in a storage medium, and include several instructions to instruct a computer device (e.g., a personal computer, a server, or a network device) to execute all or some of the method steps of each embodiment. The storage medium described above may include portable storage device, ROM, RAM, a magnetic disc, an optical disc or any other media that may store program codes.

The foregoing is only specific implementation methods of the present disclosure, and the protection scope of the present disclosure is not limited thereto. Without departing from the technical scope of the present disclosure, variations or replacements obtainable by anyone skilled in the relevant art shall all fall within the protection scope of the present disclosure. The protection scope of the subject disclosure is therefore to be limited only by the scope of the appended claims.

What is claimed is:

1. A media file browsing method, comprising:
organizing a media file set that includes a plurality of media files into one or more groups of media files, each group comprising one or more media files having a common characteristic;
displaying a display image that corresponds to the or each group of media files via a display screen; and
responsive to receiving an input command directed towards the display image, displaying the one or more media files from the group of media files that corresponds to the display image.

2. The media file browsing method according to claim 1, wherein:
the common characteristic of the one or more media files includes a first common characteristic related to media file content of the one or more media files or a second common characteristic related to media file generation time of the one or more media files.

3. The media file browsing method according to claim 1, wherein:
displaying the display image via the display screen comprises displaying a thumbnail image via the display screen.

4. The media file browsing method according to claim 3, wherein receiving the input command directed towards the display image, and displaying the one or more media files from the group of media files that corresponds to the display image comprises:
receiving a first action directed towards the display image; and
determining a first command based on the first action, to display the one or more media files from the group of media files that corresponds to the display image via an automatic media file switching mode.

5. The media file browsing method according to claim 3, wherein receiving the input command directed towards the first display image, and displaying the one or more media files from the group of media files that corresponds to the display image comprises:
receiving a second action directed towards the first display image; and
determining a second command based on the second command, to display at least one or some of the media files from the group of media files that corresponds to the display image via a thumbnail image displaying mode.

6. The media file browsing method according to claim 4, wherein:
the first action includes pressing the display image with a duration longer than a first threshold.

7. The media file browsing method according to claim 4, further comprising:
providing a first list to the display region, wherein the first list relates to one or a plurality of media files included in a group of media files that a media file currently displayed in the display region belongs to; or
providing a second list to the display region, wherein the second list relates to one or a plurality of display images; and
receiving an input command to open a media file either in the first list or the second list.

8. The media file browsing method according to claim 5, wherein:
the second action includes clicking the display image, and further comprising:
providing a first list to the display region, wherein the first list relates to one or a plurality of media files included in a group of media files that a media file currently displayed in the display region belongs to; or
providing a second list to the display region, wherein the second list relates to one or a plurality of display images; and
receiving an input command to open a media file either in the first list or the second list.

9. The media file browsing method according to claim 1, further comprising:
receiving a third action directed towards the display image; and
determining an input command corresponding to the third action based on a parameter related to the third action, and switching display content via the display screen.

10. The media file browsing method according to claim 9, wherein:
the parameter related to the third action includes an occurrence region of the third action.

11. The media file browsing method according to claim 9, wherein:
the parameter related to the third action includes a movement direction of the third action.

12. An information processing device, comprising:
a processor; and
an input device and a display unit both coupled to the processor,
wherein the processor is configured to
organize a media file set that includes a plurality of media files into one or more groups of media files, each group comprising one or more media files having a common characteristic;
display a display image that corresponds to the or each group of media files via the display unit; and
display the one or more media files from the group of media files corresponding to the display image, in response to receive an input command directed towards the display image via the input device.

13. The information processing device according to claim 12, wherein:
the common characteristic of the one or more media files includes a first common characteristic related to media file content of the or more media files or a second common characteristic related to media file generation time of the or more media files.

14. The information processing device according to claim 12, wherein:
the display unit is configured to display a thumbnail image of the display images.

15. The information processing device according to claim 14, wherein the processor is further configured to receive a first action directed towards the display image or a second action directed towards the display image,
in response to receiving the first action, the processor is further configured to determine a first command, to display the one or more media files from the group of media files via an automatic media file switching mode; and
in response to receiving the second action, the processor is further configured to determine a second command, to display at least one or some of the media files from the group of media files via a thumbnail image displaying mode.

16. The information processing device according to claim 15, wherein:
the first action includes pressing the display image with a duration longer than a first threshold; and
the second action includes clicking the display image.

17. The media file browsing method according to claim 15, wherein:
the processor is further configured to:
provide a first list to the display unit, wherein the first list relates to a plurality of media files included in a group of media files that a media file currently displayed via the display unit; or
provide a second list to the display unit, wherein the second list relates to a plurality of display images; and
receive an input command to open a media file either in the first list or the second list.

18. The information processing device according to claim 12, wherein:
the processor is further configured to:
receive a third action directed towards the display image, and
determine an input command corresponding to the third action based on a parameter related to the third action, and perform switching of display content via the display unit.

19. The information processing device according to claim 18, wherein:
the parameter related to the third action includes an occurrence region of the third action.

20. The information processing device according to claim 18, wherein:
the parameter related to the third action includes a movement direction of the third action.
